(19) United States
(12) Patent Application Publication
(10) Pub. No.: US 2011/0145023 A1
(43) Pub. Date: Jun. 16, 2011

(54) System and Method for Incentivizing Insurance Participation Utilizing Social Networking Systems

(75) Inventors: Michael Z. Stahl, Jacksonville, FL (US); Marshall Atchison, Havertown, PA (US)

(73) Assignee: Unitrin Direct Insurance Company, Chicago, IL (US)

(21) Appl. No.: 12/967,983

(22) Filed: Dec. 14, 2010

Related U.S. Application Data
(60) Provisional application No. 61/286,292, filed on Dec. 14, 2009.

(51) Int. Cl. G06Q 40/00

(52) U.S. Cl. 705/4

(57) ABSTRACT

A computer-implemented method is provide to incentivize a policy holder of an insurance company to increase membership in the insurance company. This method includes the act of, using a processing device, generating a unique code and associating the unique code to each policy holder in a memory associated with a database of policy holders. The method also includes the acts of receiving, in association with a first policy holder, a unique code associated with a second policy holder and, using the processing device or another processing device, associating the unique code of the first policy holder with the unique code of the second policy holder in the memory associated with the database. The method also includes the act of determining, using the processing device or the another processing device, if either of or both of the new policy holder and the another policy holder are entitled to a benefit responsive to the new association between the policy holders.

### CROSS-REFERENCE To RELATED APPLICATION

This application claims the benefit of priority to U.S. Provisional Patent Application No. 61/286,292, filed Dec. 14, 2009, which is hereby incorporated herein by reference in its entirely.

### TECHNICAL FIELD

The present disclosure relates generally to issuance of insurance policies and, more particularly, to incentives systems for insurance policies.

### BACKGROUND OF THE INVENTION

In the conventional insurance policy underwriting and issuance process, the insurance company makes a decision as to whether or not to offer the requested insurance to the individual and, if so, at what rate, based on information that the individual provides that is germane to the policy requested. Based on this information, the insurance company determines an appropriate premium for the policy, and prepares a policy quote for the individual's review. If the policy quote is acceptable to the individual, the individual accepts the policy quote and the policy is issued as of a specified coverage date and under specified terms.

### BRIEF SUMMARY OF THE INVENTION

In accord with at least some aspects of the present concepts, a system and method is provided for leveraging social networking systems and tools to provide incentives for an insurance carrier customer to recommend the insurance carrier to non-customers, thereby lowering new policy acquisition costs and/or improving customer loyalty by building affinity with the insurance carrier through the insurance carrier customer's friends and peers that have themselves become customers of the insurance carrier.

In still additional aspects of the present concepts, a system and method is provided for leveraging social networking systems and tools to provide incentives for an insurance carrier customer to recommend products of the insurance carrier to other friends and peers of the insurance company that are already customers, but who have not obtained policies for such recommended products, thereby lowering policy acquisition costs and/or improving customer loyalty by increasing points of contact with the insurance carrier.

In another aspect, a computer-implemented method for incentivizing a policy holder of an insurance company to increase membership in the insurance company includes the acts of storing, in a memory associated with a network database, a unique code associated with each policy holder in the insurance company and receiving on a first computer, in association with receipt of information for a new insurance policy application, a unique code associated with a first policy holder. The method further includes transmitting to a second computer from the first computer, or from another computer, responsive to the act of receiving, a quote for the new insurance policy, the quote incorporating a benefit attributed to the receiving of the unique code associated with the first policy holder and receiving on the first computer, or the another computer, an acceptance of the quote for the new insurance policy from the second computer. The method also includes the act of issuing the new insurance policy to a new policy holder following acceptance of the quote incorporating the benefit, the act of issuing further comprising the act of updating the memory associated with the network database to store a unique code in association with the new policy holder. The method further includes the acts of storing, in the memory associated with the network database or another database, an association between the unique code of the first policy holder and the unique code stored in association with the new policy holder and providing a benefit to the first policy holder responsive to the act of issuing the new insurance policy, the benefit being the same as or different from the benefit incorporated in the new insurance policy.

In another aspect of the present concepts, a computer-implemented method is provide to incentivize a policy holder of an insurance company to increase membership in the insurance company. This method includes the act of, using a processing device, generating a unique code and associating the unique code to each policy holder in a memory associated with a database of policy holders. The method also includes the acts of receiving, in association with a first policy holder, a unique code associated with a second policy holder and, using the processing device or another processing device, associating the unique code of the first policy holder with the unique code of the second policy holder in the memory associated with the database. The method also includes the act of determining, using the processing device or the another processing device, if either of or both of the new policy holder and the another policy holder are entitled to a benefit responsive to the new association between the policy holders.

In yet another aspect, a computer-implemented method for incentivizing a policy holder of an insurance company to increase membership in the insurance company includes the acts of defining, in an interface displayed on an electronic device display, at least one benefit available to a policy holder for bringing a new customer to the insurance company and providing, in the interface displayed on the electronic device display, a contact information data entry field into which a referring policy holder can input contact information for a referee non-policy holder. The method also includes the act of using the electronic device, or another electronic device, transmitting a policy quote to the referee non-policy holder, the policy quote incorporating a benefit associated with the referring policy holder. The method also includes issuing an insurance policy to the referee responsive to an acceptance of the quote and providing a benefit to the referring policy holder responsive to the issuing of the new insurance policy to the referee, wherein the benefit provided to the referring policy holder may be the same as or different from the benefit provided to the referee.

In at least one aspect of the present concepts, the incentive to be provided to a insurance carrier customer is a discounted premium on insurance. Other discounts may include, but are not limited to, discounts on insurance-based fees.

### BRIEF DESCRIPTION OF THE DRAWINGS

FIGS. 1(a)-1(g) are representations of at least some aspects of the present concepts.

FIGS. 2(a)-2(f) are representations of at least some aspects of the present concepts.

FIG. 3 is a representation of at least some aspects of the present concepts.

FIG. 4 is a depiction of a computer system upon which aspects of at least some embodiments of the present concepts may be implemented.

While the invention is susceptible to various modifications and alternative forms, specific embodiments have been shown by way of example in the drawings and will be described in detail herein. It should be understood, however, that the invention is not intended to be limited to the particular forms disclosed.

### DETAILED DESCRIPTION

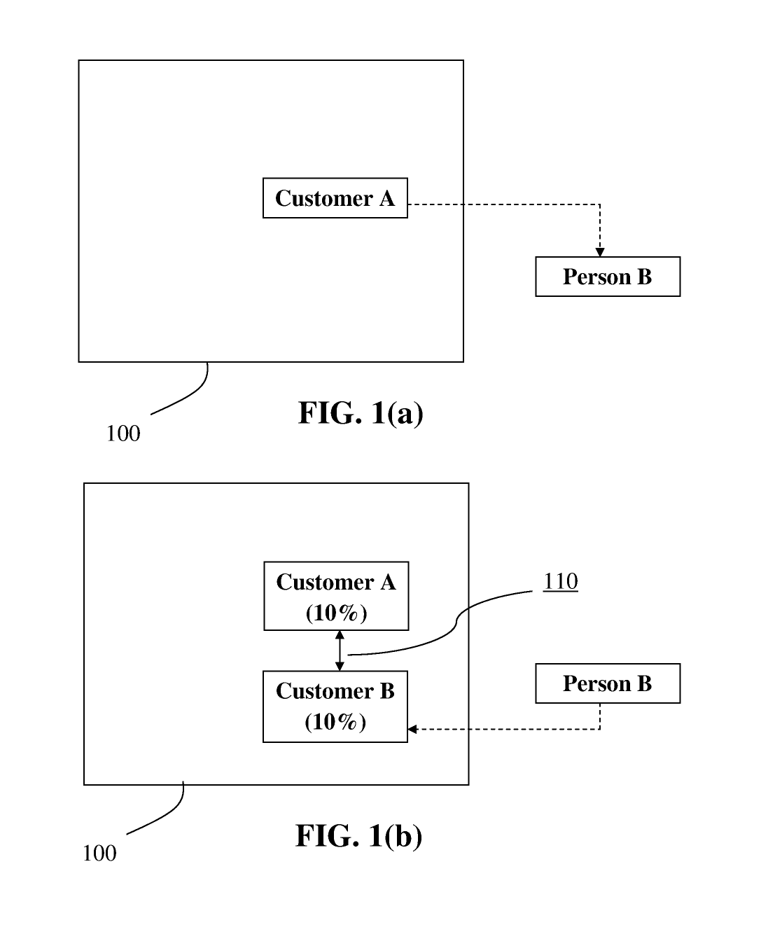

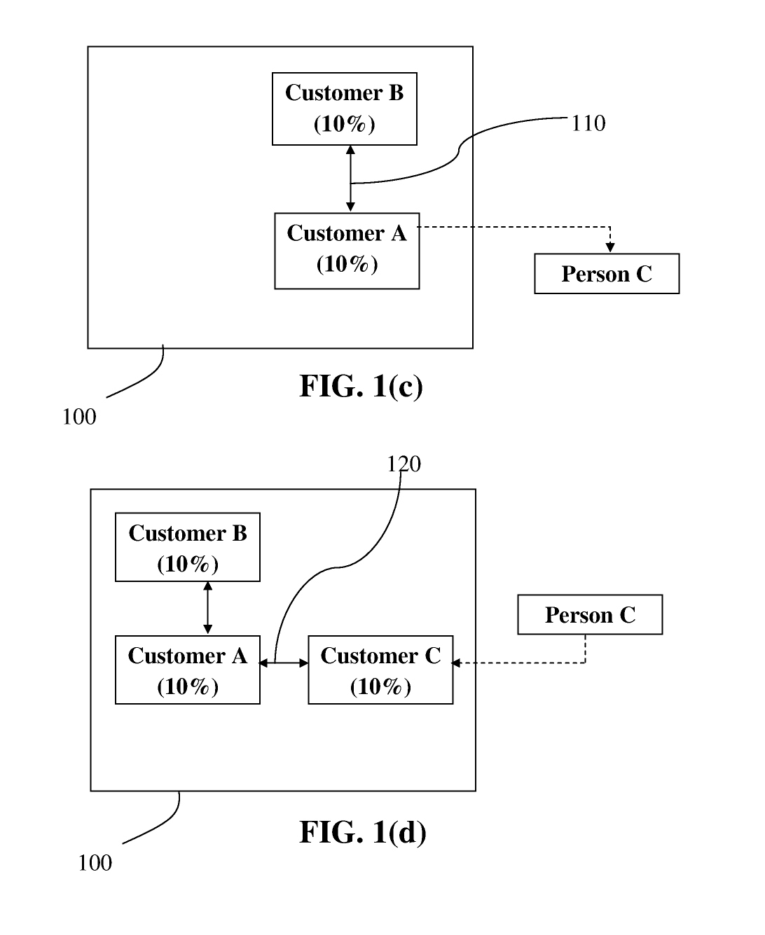

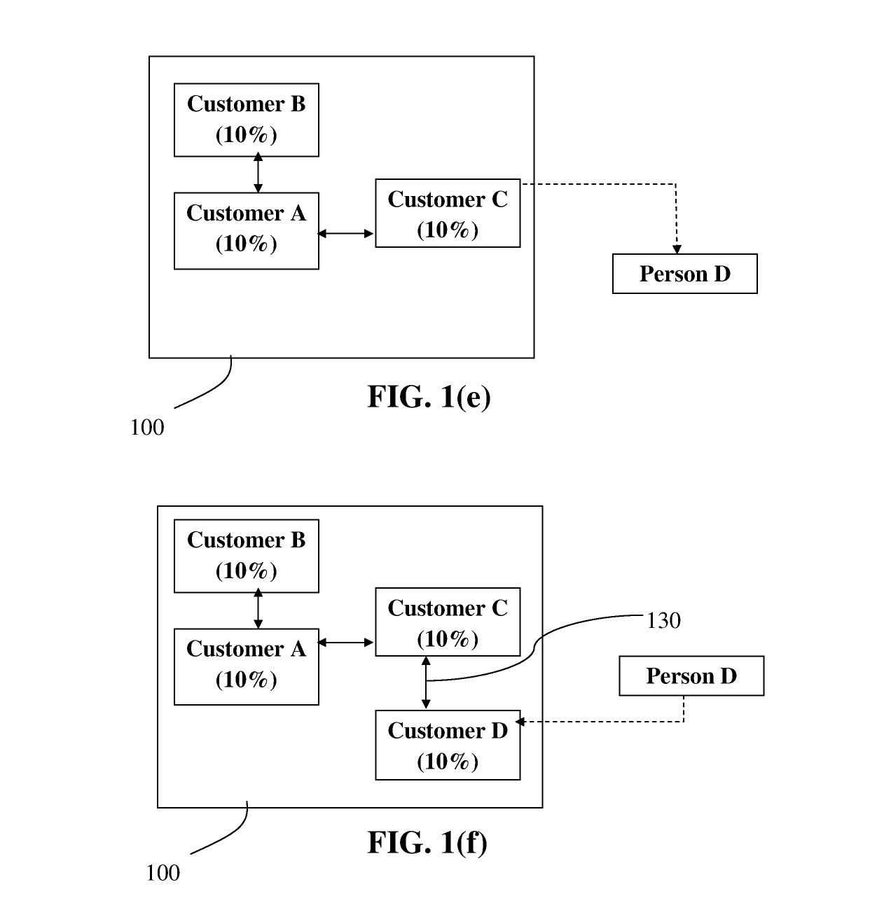

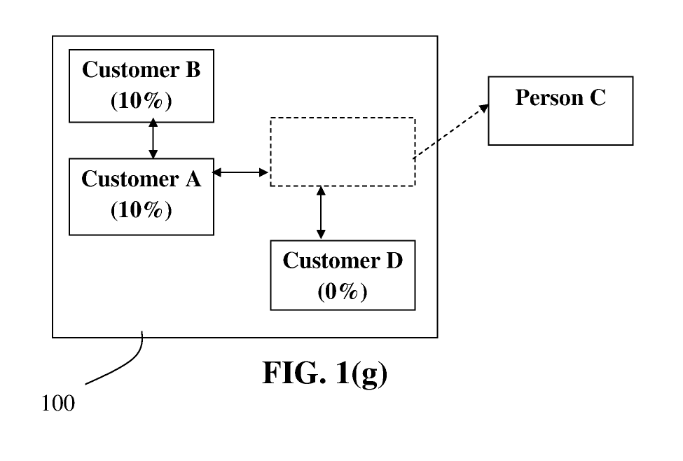

In at least some aspects of some embodiments of the present concepts, represented by FIGS. 1(a)-1(g), a first customer of the insurance carrier 100, Customer A, buys a policy. The policy could be, for example, for any and all lines of insurance including any one or more of auto policy, home policy, condo policy, renters policy, umbrella policy, boat owners policy, inland marine policy, snowmobile policy, motorcycle policy, ATV policy, personal insurance product policy, other insurance product policy, or any combination thereof. As shown in FIG. 1(b), Customer A in turn communicates with a friend, peer, acquaintance, or other person, Person B, that is not a customer of insurance carrier 100. Person B then communicates with the insurance carrier 100 and decides to obtain one or more policies from the insurance carrier 100, thereby becoming Customer B. In the process of communicating with the insurance carrier and obtaining the one or more policies from the insurance carrier 100, Customer B references Customer A as the source of the referral. The insurance carrier 100, in accord with the example of FIGS. 1(a)-1(g), links the policy of Customer B to the policy of Customer A in its database, as is represented by the arrow 110 and notifies Customer A and Customer B that their policies are now linked together with respect to a mutual benefit that each will receive. In this example, the benefit is the same to both Customer A and Customer B, but in other aspects of the present concepts, the benefits can be different and, more particularly, can be varied in accord with parameters such as the number of persons that the customer (e.g., Customer A) is able to bring into the insurance carrier. Responsive to the linkage of Customer A and Customer B, represented in FIG. 1(b), each of Customer A and Customer B receives a predetermined benefit which, as shown in FIG. 1(b) in this example, is a 10% discount on each customer's premium (e.g., for a single premium or for multiple premiums in various embodiments).

Continuing with the above example, FIG. 1(c) shows that Customer A communicates with a friend, peer, acquaintance, or other person, Person C, that is not a customer of insurance carrier 100. Person C then communicates with the insurance carrier 100 and decides to obtain one or more policies from the insurance carrier 100, thereby becoming Customer C. In the process of communicating with the insurance carrier and obtaining the one or more policies from the insurance carrier 100, Customer C references Customer A as the source of the referral. The insurance carrier 100 links the policy of Customer C to the policy of Customer A in its database, as is represented by the arrow 120 and notifies Customer A and Customer C that their policies are now linked together with respect to a mutual benefit that each will receive. Responsive to the linkage of Customer A and Customer C, represented in FIG. 1(d), Customer C receives a predetermined benefit which, as shown in FIG. 1(d) in this example, is a 10% discount on their premium (e.g., for a single premium or for multiple premiums in various embodiments). In the example represented in FIG. 1(d), Customer A receives no additional direct benefit (e.g., no additional premium reduction). Customer A does receive a benefit in that, should either Customer B or Customer C leave the insurance carrier 100 or cancel any policy or policies that are linked to Customer A, Customer A will still have an existing linkage with the other one of Customer B or Customer C and will retain the 10% premium discount, as is shown in FIG. 1(g).

In FIG. 1(e), Customer C communicates with a friend, peer, acquaintance, or other person, Person D, that is not a customer of insurance carrier 100. Person D then communicates with the insurance carrier 100 and decides to obtain one or more policies from the insurance carrier 100, thereby becoming Customer D. In the process of communicating with the insurance carrier and obtaining the one or more policies from the insurance carrier 100, Customer D references Customer C as the source of the referral. The insurance carrier 100 links the policy of Customer D to the policy of Customer C in its database, as is represented by the arrow 130 and notifies Customer C and Customer D that their policies are now linked together with respect to a mutual benefit that each will receive. Responsive to the linkage of Customer C and Customer D, represented in FIG. 1(f), Customer D receives a predetermined benefit which, as shown in FIG. 1(f) in this example, is a 10% discount on their premium (e.g., for a single premium or for multiple premiums in various embodiments). In the example represented in FIG. 1(f), Customer C receives no additional direct benefit (e.g., no additional premium reduction). Customer C does however, as noted above, receive a benefit in that, should either Customer A or Customer D leave the insurance carrier 100 or cancel any policy or policies that are linked to Customer C, Customer C will still have an existing linkage with the other one of Customer A or Customer D and will retain the 10% premium discount, such as is shown in FIG. 1(g).

FIG. 1(g) shows that Customer C has left the insurance carrier 100 and severed the linkage with the policies of Customer A and Customer D. Since Customer A still has an existing linkage with Customer B, Customer A retains the 10% premium discount, as is shown in FIG. 1(g). However, Customer D, who was only linked to Customer C, has now lost their 10% premium discount.

In the example of FIGS. 1(a)-1(g), the benefit is shown to be an equal 10% discount on the policy premium. The present concepts include lesser or greater amounts and conceptually could include any benefit between 0-100% on a current policy. Additionally, the benefit may optionally be of a limited term, but advantageously be permitted to accrue to future issuances of policies. For example, rather than being a perpetual benefit that endures so long as two linked participants remain with the insurance carrier 100, the benefit may carry with it an expiration (e.g., one year). Thus, to retain the benefit, each Customer is incentivized to bring in yet additional new customers to the insurance carrier. In such a paradigm, if a customer brings into the insurance carrier 100 multiple customers in a given year, the added benefit may be appended to the end of the prior benefit periods (e.g., bringing in two customers would provide two consecutive one-year premium reductions).

However, in at least some other aspects of the present concepts, the benefit may be unequal, with a greater benefit accruing to the current customer (e.g., Customer A) and a lesser benefit accruing to the new customer (e.g., Customer B). For example, in an example assuming a 10% cap on the permissible discounted premium, a current customer, Customer A, may receive a 7% premium reduction for bringing in a new customer, Customer B, whereas Customer B receives only a 5% premium reduction. In such example, should Customer B later bring in another new customer, Customer C, then Customer B is awarded an additional premium reduction (e.g., 1%, 2%, . . . 5%) to either bring Customer B closer to the 10% cap on the permissible discounted premium or to the 10% cap on the permissible discounted premium. Of course, the percentages presented in this paragraph and herein are merely exemplary and are not intended to be limiting in any respect.

Although the term benefit has been described using a premium discount as an example, other benefits are contemplated as being within the present concepts. In various other examples, the benefit could be added coverage(s), reduction in a deductible or deductibles, enhanced service levels (e.g., maybe you have a personal service/agent representative providing enhanced or expedited services), products from an insurance carrier store (e.g., insurance company branded products) or third party site associated with the insurance carrier (e.g., home safety products, discounts on installations of car alarm systems, discounts on home alarm systems, etc.). The benefits may be utilized immediately by the customer, or the customer may be permitted to collect the benefits to enable the customer access to higher valued benefits.

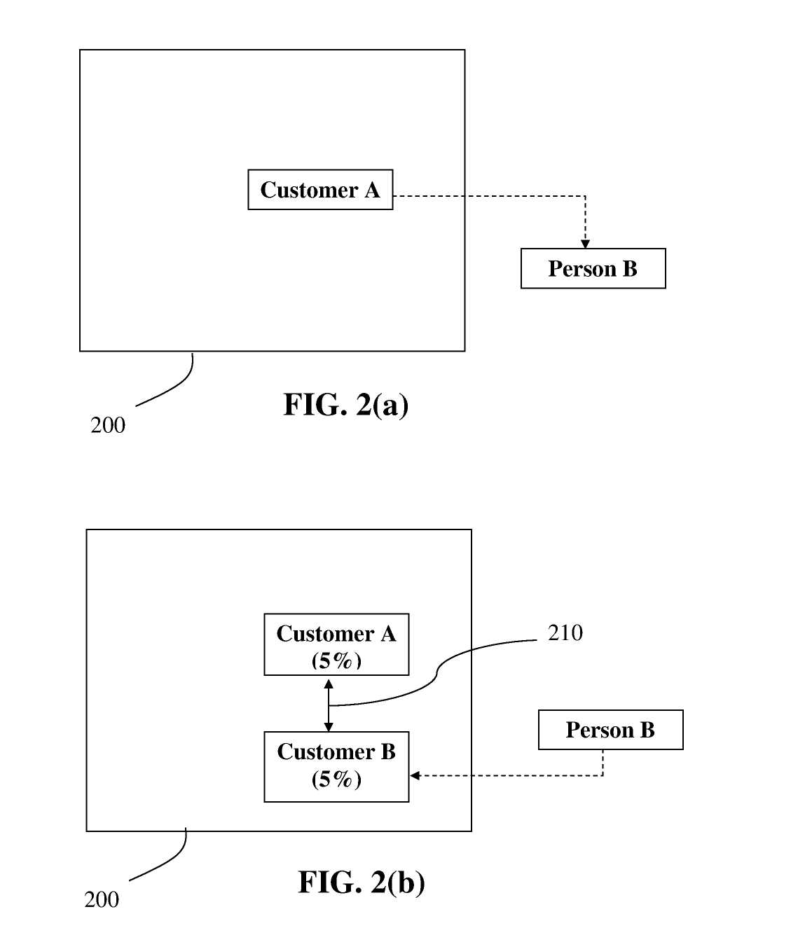

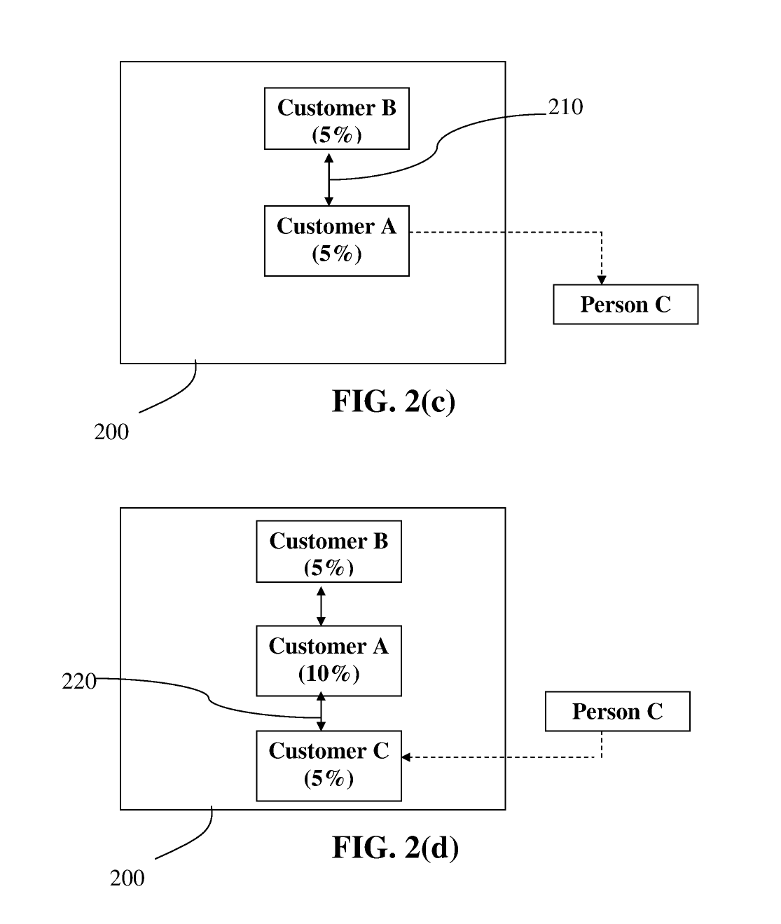

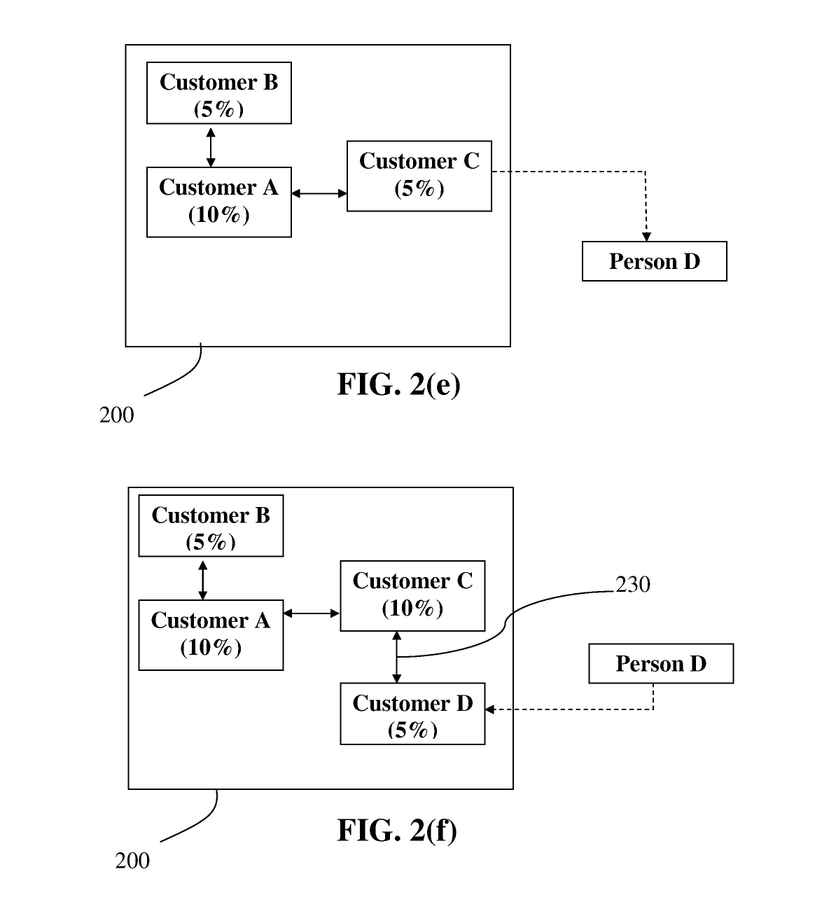

In at least some other aspects of some embodiments of the present concepts, represented by FIGS. 2(a)-2(f), a first customer of the insurance carrier 200, Customer A, buys a policy (e.g., an auto policy, home policy, condo policy, renters policy, umbrella policy, boat owners policy, inland marine policy, snowmobile policy, motorcycle policy, ATV policy, personal insurance product policy, other insurance product policy, or any combination thereof). As shown in FIG. 2(b), Customer A in turn communicates with a friend, peer, acquaintance, or other person, Person B, that is not a customer of insurance carrier 200. Person B then communicates with the insurance carrier 200 and decides to obtain one or more policies from the insurance carrier 200, thereby becoming Customer B. In the process of communicating with the insurance carrier and obtaining the one or more policies from the insurance carrier 200, Customer B references Customer A as the source of the referral. The insurance carrier 200, in accord with the example of FIGS. 2(a)-2(f), links the policy of Customer B to the policy of Customer A in its database, as is represented by the arrow 210 and notifies Customer A and Customer B that their policies are now linked together with respect to a mutual benefit that each will receive. Responsive to the linkage of Customer A and Customer B, represented in FIG. 2(b), each of Customer A and Customer B receives a predetermined benefit which, as shown in FIG. 2(b) in this example, is a 5% discount on each customer's premium (e.g., for a single premium or for multiple premiums in various embodiments).

Continuing with the above example, FIG. 2(c) shows that Customer A communicates with a friend, peer, acquaintance, or other person, Person C, that is not a customer of insurance carrier 200. Person C then communicates with the insurance carrier 200 and decides to obtain one or more policies from the insurance carrier 200, thereby becoming Customer C. In the process of communicating with the insurance carrier and obtaining the one or more policies from the insurance carrier 200, Customer C references Customer A as the source of the referral. The insurance carrier 200 links the policy of Customer C to the policy of Customer A in its database, as is represented by the arrow 220 and notifies Customer A and Customer C that their policies are now linked together with respect to a mutual benefit that each will receive. Responsive to the linkage of Customer A and Customer C, represented in FIG. 2(d), Customer C receives a predetermined benefit which, as shown in FIG. 2(d) in this example, is a 5% discount on their premium (e.g., for a single premium or for multiple premiums in various embodiments). In the example represented in FIG. 2(d), Customer A does receive an additional direct benefit in an additional premium reduction to take Customer A's total premium reduction to 10%. Customer A further receives a benefit in that, should either Customer B or Customer C leave the insurance carrier 200 or cancel any policy or policies that are linked to Customer A, Customer A will still have an existing linkage with the other one of Customer B or Customer C and will retain a 5% premium discount.

In FIG. 2(e), Customer C communicates with a friend, peer, acquaintance, or other person, Person D, that is not a customer of insurance carrier 200. Person D then communicates with the insurance carrier 100 and decides to obtain one or more policies from the insurance carrier 200, thereby becoming Customer D. In the process of communicating with the insurance carrier and obtaining the one or more policies from the insurance carrier 200, Customer D references Customer C as the source of the referral. The insurance carrier 200 links the policy of Customer D to the policy of Customer C in its database, as is represented by the arrow 230 and notifies Customer C and Customer D that their policies are now linked together with respect to a mutual benefit that each will receive. Responsive to the linkage of Customer C and Customer D, represented in FIG. 2(f), Customer D receives a predetermined benefit which, as shown in FIG. 2(f) in this example, is a 5% discount on their premium (e.g., for a single premium or for multiple premiums in various embodiments). In the example represented in FIG. 2(f), Customer C does receive an additional direct benefit in an additional premium reduction to take Customer C's total premium reduction to 10%. Customer C further receives a benefit in that, should either Customer A or Customer D leave the insurance carrier 200 or cancel any policy or policies that are linked to Customer C, Customer C will still have an existing linkage with the other one of Customer A or Customer D and will retain a 5% premium discount.

In at least some other aspects of some embodiments of the present concepts, a first customer of the insurance carrier, Customer A, buys a policy. Customer A in turn brings a customer, Customer B, to the insurance carrier and Customer B buys a policy, referencing Customer A in the process. The insurance carrier notifies Customer A that Customer B has requested a linkage of their policy of the policy of Customer A. Customer A is then empowered to accept that request. Upon Customer A's acceptance of the requested linkage, both Customer A and Customer B may optionally be required to perform an additional act, such as agreeing to additional terms and conditions that are attached by the insurance carrier to the requested linkage. In one aspect, the additional terms and conditions may comprise a pledge to agree to perform certain acts consistent with the policy and/or to refrain from certain acts that would be inconsistent with the policy. Following the pledge by Customer A and Customer B to abide by such additional terms, both Customer A and Customer B then are each granted the discount or other predetermined benefit.

The example of FIGS. 2(a)-2(f) shows one instance wherein customers of the insurance carrier 200 are permitted to not only link with or “mingle” with more than one other customer of the insurance carrier 200 network (e.g., an “iMingle Network”), but that the discount received therefrom may optionally increment higher as a result of such additional links. In contrast, in the example of FIGS. 1(a)-1(g), the customers did not receive any incremental discount for additional links.

In one example of such pledge to agree to perform certain acts consistent with the policy and/or to refrain from certain acts that would be inconsistent with the policy, wherein the linkage between customers is referred to as “mingling” on the “iMingle Network” and the parties would be members of Customer A's iMingle Network, the pledge may comprise, by way of example, a safe driving pledge:

1. I will follow all laws and traffic safety rules.

I will obey speed limits, traffic signs and signals. My passengers and I will wear our seatbelts at all times. I will not drive under the influence of alcohol or drugs, and will not ride in a vehicle driven by someone who is under the influence.

2. I will drive safely and responsibly.

I will drive defensively, and will not race, speed, tailgate or cut others off in traffic. I will remain alert while driving, and will not drive when I am angry, over tired, or in a physical or emotional condition that can impair my driving. I will be aware of conditions that can affect driving such as weather or lower visibility at night.

3. I will not allow myself to be distracted while driving.

I will use my mobile phone safely, and will not text while driving. I will not smoke, eat, apply makeup, or perform other actions that take my attention away from the road. I will make sure that the car stereo volume allows me to hear sounds outside of the car, and will not wear earphones while driving.

4. I will maintain my vehicle in a safe condition.

I will make sure that my brakes and lights work, that my tires are properly inflated, and that all of the vehicle's vital systems are functioning properly.

5. I will encourage members of my iMingle Network to do these things, too.

As another example of additional terms and conditions consistent with the policy and/or to refrain from certain acts that would be inconsistent with the policy, the customers may be required to agree to conditions (e.g., further to the aforementioned pledge) in consideration of a reduced premium, such as:
A. Within 30 days of the original effective date of the policy, and after you have agreed to the Pledge, you designate at least one person as being part of your iMingle Network for this policy period.
B. At any other time that you agree to the Pledge, you must immediately designate at least one person as being part of your iMingle Network for this policy period.
C. After you agree to the Pledge, we will notify you if you do not have at least one person designated as being part of your iMingle Network at any time during the policy period. To continue the reduced premium, you agree to add a person as being part of your iMingle Network within 30 days after our notification.
D. You agree that we may notify each person designated as being part of your iMingle Network if this policy is terminated.
E. A person designated as being part of your iMingle Network must be insured by us or our affiliate.

In accord with at least some aspects of the present concepts, the agreement to a safety pledge, noted above, is required. However, in accord with other aspects of the present concepts, the agreement to a safety pledge is not required for the discount or other benefit.

In at least some aspects of some embodiments of the present concepts, the premium discount (referred to herein, by way of example, as a “iMingle Discount”, “iMingle Network Discount”, etc.), or other benefit, continues so long as a customer is associated with (e.g., electronically linked to in a network database) with at least one other person in the insurance carrier network (e.g., “iMingle Network”).

Upon the policy cancellation or non-renewal on the part of a linked customer in the insurance carrier network (e.g., “iMingle Network”), the affected customers are notified (e.g., via email, text alert, web posting, text message, or other electronic communication that the specified linkage no longer exists, or alternatively via surface/air mail or telephone call).

Where regulatory agencies permit, linked groups of a certain minimum size in the insurance carrier network (e.g., “iMingle Network”) may be “group rated” such that the rates of the group could be influenced by the claims experience of the group.

As noted above, customers of the insurance carrier 100, 200 can communicate the availability of the premium discount or other benefit offering to non-customer(s) and extend themselves as potential “iMingle Mates” or the like to such non-customer(s). This communication may occur using any manner of electronic or non-electronic communication (e.g., via a customer's cell phone, computer email account, etc.) and will require the customer to provide the non-customer with some type of information or code identifying the customer. When the non-customer obtains a quote, such as through a web interface, or possibly even through a telephone call with an insurance carrier representative, the non-customer inputs or otherwise conveys the information or code provided by the customer that is to be associated with them in the insurance carrier network (e.g., “iMingle Network”) and the web interface application (or representative) then provides to the non-customer an associated policy quote incorporating the discount or benefit associated with the linkage to the indicated customer. Should the non-customer accept the quote and ratify the policy (or policies) to thereby become a customer of the insurance carrier, the new customers policy (or policies) is thereafter electronically linked to or associated with the designated customer in the insurance carrier network (e.g., “iMingle Network”).

To facilitate implementation of the linking communications, and to enhance customer privacy, customers may initially be assigned unique identifying codes, which the customer may elect to modify. The code could be provided by the insurance carrier to the customer verbally (e.g., via a representative of the insurance carrier), through an electronic communication (e.g., email, text message, etc.), through surface/air mail, or through the insurance carrier's website (e.g., accessing a navigation link provided to customer). Alternatively, the customer may be allowed to simply designate their own identifying code or user name, such as by entering a code into a telephone or by selection of a code through the insurance carrier's website.

Once the customer possesses the code, the customer can then provide the code to a non-customer verbally, through an electronic communication (e.g., email, text message, etc.), surface/air mail, or any other method of communication (e.g., in writing, through an intermediary, etc.). Alternatively, the insurance carrier may be situated as an intermediary for the customer and the customer provides to the insurance carrier the contact information of the non-customer (e.g., an email address) and the insurance carrier then contacts the non-customer to provide, for example, a unique hyper-link enabling that non-customer to directly enter the insurance carrier quoting engine with the quoting engine being preferably, but not necessarily, automatically populated with the referring customers' unique identifying code. In still another example, a customer may provide, on a separate third party social networking site to which they are associated, a hyper-link or other navigation link providing a link to the insurance carrier quoting engine. The use of the hyper-link or other navigation link may itself automatically populate the quoting engine with the referring customers' unique identifying code or, optionally, the non-customer may be required to enter such code. Similarly, the customer may provide a hyper-link or other navigation link to a non-customer via a mobile application, such that the non-customer would be enabled to access the insurance carrier quoting engine using a mobile device (e.g., cellular phone, laptop, BlackBerry, etc.).

Upon a new individual indicating to the insurance carrier quoting engine (e.g., via unique code, unique web hyperlink, verbally or otherwise) that they wish to be associated with or electronically linked to an existing customer (policyholder) in an insurance carrier network (e.g., “iMingle Network”), a validation process preferably occurs to enable the existing customer to verify their acceptance of a linkage to that new individual in the insurance carrier network. This could occur, by way of example, as follows. First, upon input of a customer's unique code in the context of a requesting linking (e.g., a non-customer has input the customer's unique code, utilized a unique navigation link, or the like), the existing customer is notified of the request via an automatic email, text alert or other electronic communication. Second, the existing customer would have the ability to accept or reject that individual by, for example, clicking on a button associated with that choice either in the email, text or other electronic communication or via the insurance carrier website. Third, if the existing customer accepts linkage to the individual, the electronic linkage of or association to the indicated customer in the insurance carrier network (e.g., the “iMingle Network”) would be implemented. If the existing customer did not accept linkage to the individual, the linkage would not occur and a notifying electronic communication would be sent to that individual.

In various aspects, web, mobile or other computer applications can communicate the accumulation of savings that one person has afforded to all of their Mates. For example, if Customer A is linked to Customers B, C, and D, and those individuals have saved $50, $75, and $25 respectively from the associated discount (e.g., “iMingle Discount”), the application would have the ability to communicate that Customer A has saved his or her friends a total of $150 on their insurance. Likewise, web, mobile or other computer applications can also communicate, via an associated display, the insurance carrier network and those persons associated with the customer in the insurance carrier network (e.g., “iMingle Network”) so the customer (or other authorized representative accessing the information) may see graphically to whom they are linked, how long their association has been with that other customer, the amount of savings they have obtained themselves or for the other customers with whom they are associated in the insurance carrier network (e.g., “iMingle Network”), etc. Such applications advantageously comprise a relationship database that stores the linkages between various parties (e.g., stores the associations between the various customers).

In some aspects, web and mobile applications can be provided that graphically display direct links to the other customers with whom they are associated in the insurance carrier network (e.g., “iMingle Network”) and indirect links to other customers of the insurance carrier with whom they are not associated in the insurance carrier network, optionally with graphical indications of predetermined characteristics, such as the strength of a relationship, whether the person is a direct “friend” or a “friend of a friend,” the age of the relationship, current discounts, accumulated discounts applied due to the relationships between the customers in the insurance carrier network (e.g., “iMingle Network”), etcetera, or combinations thereof.

In still other aspects, persons who are participants in the insurance carrier network (e.g., “iMingle Network”) may be advantageously permitted to opt in to receive notices (e.g., emails, text messages, etc.) whenever there is a change to their network of linked customers, such as when the customers' network of influence grow more robust either by adding people directly or indirectly, or if multi-line policies are purchased.

Advantageously, privacy concerns are intrinsic to the system, with actual customer names either only being displayed for directly-linked participants in the insurance carrier network (e.g., “iMingle Network”) and/or only displayed following authorization for such display by the individual customers (e.g., upon the setting of a filter in an application permitting such display).

If desired, customers may further be permitted to create an on-line character/screen name that could be optionally displayed. Accordingly, in accord with such aspects, a system in accord with the present concepts may advantageously permit customers to create an online avatar to represent themselves for display and/or communication purposes.

In at least some aspects, a system in accord with the present concepts provide not only an electronic communication (e.g., email, text message, etc.) alerting the customer that the customer has lost a linkage to or association with another person in the insurance carrier network (e.g., “iMingle Network”) that might reduce their current premium discount level or other realized benefit, but the system may optionally provide the customer with a grace period (e.g., 7 days, 14 days, 1 month, 2 months, etc.) to provide the customer with some time to adjust to the imminent change or to permit the customer to try to obtain another linkage to or association with yet another person in the insurance carrier network (e.g., “iMingle Network”).

In at least some aspects, “Six Degrees of Kevin Bacon” functionality will be provided by permitting a search by name or email address. If a match is found—a graphical representation will be provided to illustrate the path to the person. If a match is not found, an option to invite the person via email will be provided if the email address is known. Thus facilitating another means whereby a customer can build their network of Mates.

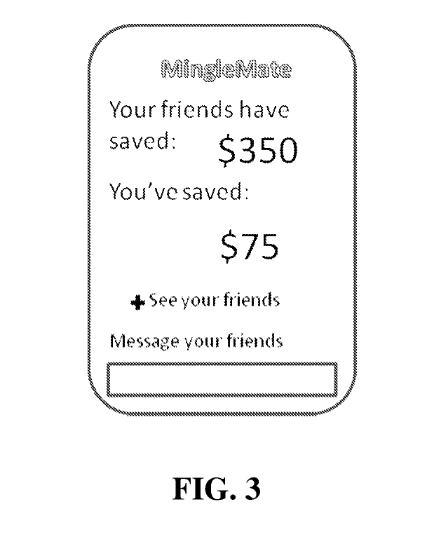

FIG. 3 shows an example of a representation of a display of a web, social network, or mobile application.

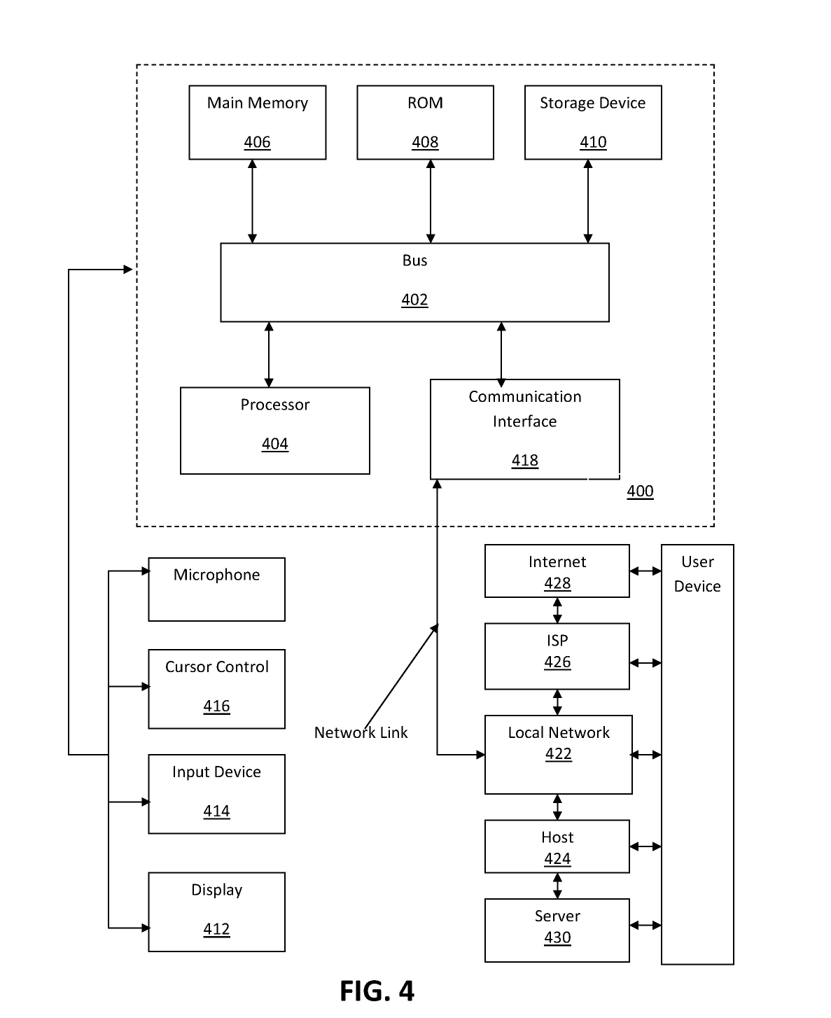

FIG. 4 is a block diagram that illustrates an example of a computer system 400 upon which embodiments of the present concepts may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412.

The invention is related to the use of computer system 400 for practicing the various aspects of the present concepts disclosed herein. According to one embodiment of the invention, various aspects of the present concepts disclosed herein are provided by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media include, for example, optical or magnetic disks, such as storage device 110. Volatile media include dynamic memory, such as main memory 106. Transmission media include coaxial cables, copper wire and fiber optics, including the wires that comprise bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, or any other medium from which a computer can read.

Various forms of computer readable media may be involved in carrying one or more sequences of one or more instructions to processor 104 for execution. For example, the instructions may initially be borne on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424, to data equipment operated by an Internet Service Provider (ISP) 426, or to a cellular network. ISP 426 in turn provides data communication services through the Internet 428. Local network 422 and Internet 428 both use electrical, electromagnetic or optical signals that carry digital data streams.

Computer system 400 can send messages and receive data, including program code, through the network(s), network link 420, and communication interface 418. In the Internet example, a server 430 might transmit a requested code for an application program through Internet 428, ISP 426, local network 422 and communication interface 418. In accordance with the invention, one such downloaded application provides for various aspects of the present concepts disclosed herein. The received code may be executed by processor 404 as it is received, and/or stored in storage device 410, or other non-volatile storage for later execution.

The above computer system 400 is, in view of the above, programmable as a special purpose computer to implement the aspects of the concepts disclosed herein, either individually or in any combination, of a network configured to provide incentives for an insurance carrier customer to participate in an insurance carrier social network and/or to increase and/or maintain membership of others in the insurance carrier through the insurance carrier social network, such incentives including, but not limited to discounted insurance carrier offerings for specified time periods, enhanced bonus coverage (e.g., free reduction in an auto policy deductible from $1000 to $500 or $500 to $100, free sump pump back-up coverage in a home policy, etc.). As one example, a plurality of levels of offerings could be presented to a customer in accord with their individual level of participation in the insurance carrier network (e.g., “iMingle Network”) such that, for example, the greater the number of new customers that they bring into the insurance carrier, the greater the level of the benefits that they may receive.

Further, in still other aspects, the customer (e.g., Customer A) and the prospective customer (e.g., person B) may be provided the option of selecting a benefit from a plurality of available benefits, so that each of Customer A and person B, who then becomes Customer B, may tailor their benefit to their own individual needs. For example, Customer A may desire to obtain a premium reduction selected from a preferred tier of such premium reductions, whereas person B/Customer B may opt to select from an introductory tier of reduced policy deductibles.

In yet another variation of the concepts disclosed herein, a level of a benefit provided, such as but not limited to a discount on a customer's premium, may be tied to a number of linkages or associations with other persons in the insurance carrier network (e.g., “iMingle Network”) and/or a depth of such linkages (e.g., duration, number of insurance products, etc.) and/or a claim-status of one or more such linkages (e.g., accident free, non-fault accident(s), one fault-based accident, etc.). By way of example, an enhanced benefit may be provided based on both the number of linkages or associations with other persons in the insurance carrier network and the claim-status of such linkages. For example, an enhanced benefit is not available is there are less than five members in the individuals' iMingle Network, but an additional 2.5% discount is provide to the individual if the individual has five or more members that are all claim-free in the past year. In this exemplary scheme, an additional 5% discount is provide to the individual if the individual has twenty or more members that are all claim-free in the past year and an additional 7.5% discount is provide to the individual if the individual has fifty or more members that are all claim-free in the past year. Of course, these numbers are provided purely as an illustration of the conditioning of enhanced benefits on the relationship between the individual and others in the insurance carrier network and, for example, the noted enhanced discount amounts could be higher or lower and the number of member thresholds could change. By way of example, the “claim-free” item could optionally be more lenient (e.g., it could apply if 90% of, or some other percentage of, the individuals' members are claim-free instead of all of them). Moreover, the availability of the enhanced benefits may further be contingent upon a status of the individual himself or herself, such as, for example, requiring that individual to be claim-free as well over a predetermined period.

It yet other aspects, a benefit or an enhanced benefit, as generally noted above, is optionally made available only if the individual accepting the discounted premium pays a certain minimum amount of the indicated premium up-front or contemporaneously with the issuance of the policy (e.g., paying for 50% of the premium up-front, with the balance being allocated to equal subsequent monthly payments, etc.).

In another aspect, a new policy holder is provided a predetermined period of time to bring in new policy holders into the insurance carrier network (e.g., “iMingle Network”) before the benefit can accrue. For example, a new policy holder may be provided a period of one week, two weeks, a month, two months, etc., to bring in one new policy holder, at which time, both new policy holders each receive a 10% discount.

In one aspect, a computer-implemented method for incentivizing a policy holder of an insurance company to increase membership in the insurance company is provided and includes an act of storing, in a memory associated with a network database, a unique code associated with each policy holder in the insurance company. The method further includes an act of receiving on a first computer, in association with receipt of information for a new insurance policy application, a unique code associated with a first policy holder and transmitting to a second computer, responsive to the act of receiving, a quote for the new insurance policy, the quote incorporating a benefit, such as noted above, attributed to the receiving of the unique code associated with the first policy holder. The method further includes receiving on the first computer, or the another computer, an acceptance of the quote for the new insurance policy from the second computer (i.e., from the prospective policy holder) and issuing the new insurance policy to a new policy holder following acceptance of the quote incorporating the benefit. The method further includes the acts updating the memory associated with the network database to store a unique code in association with the new policy holder and storing, in the memory associated with the network database or another database, an association between the unique code of the first policy holder and the unique code stored in association with the new policy holder. Lastly, this method includes the act of providing a benefit to the first policy holder responsive to the act of issuing the new insurance policy, the benefit being the same as or different from the benefit incorporated in the new insurance policy.

In one optional aspect, the method described above further includes the acts of receiving on a first computer associated with the insurance company, a request by a policy holder to add an association with a unique code associated with one or more other policy holder(s). Following receipt of and verification of these unique codes by the insurance company, the first computer or another computer updates the association between the policy holder and the one or more other policy holder(s) in the memory associated with the network database. Further, the method includes determining, using a processing device communicatively coupled to the network database, if either of or both of the policy holder and other policy holder(s) are entitled to a benefit responsive to the new association between the policy holders.

In various aspects of the present concepts, the above described computer-implemented method for incentivizing a policy holder of an insurance company to increase membership in the insurance company includes the acts of processing, using a processing device communicatively coupled to the network database, a change in a status of a policy holder and processing, using the processing device or another processing device communicatively coupled to the network database, a change in a status of another policy holder, not related to the policy holder (i.e., not a family member), relative to the change in status of the policy holder.

Each of these embodiments and obvious variations thereof is contemplated as falling within the spirit and scope of the claimed invention, which is set forth in the following claims.

What is claimed:

1. A computer-implemented method for incentivizing a policy holder of an insurance company to increase membership in the insurance company comprising the acts of:
storing, in a memory associated with a network database, a unique code associated with each policy holder in the insurance company;
receiving on a first computer, in association with receipt of information for a new insurance policy application, a unique code associated with a first policy holder;
transmitting to a second computer from the first computer, or from another computer, responsive to the act of receiving, a quote for the new insurance policy, the quote incorporating a benefit attributed to the receiving of the unique code associated with the first policy holder;
receiving on the first computer, or the another computer, an acceptance of the quote for the new insurance policy from the second computer;
issuing the new insurance policy to a new policy holder following acceptance of the quote incorporating the benefit, the act of issuing further comprising the act of updating the memory associated with the network database to store a unique code in association with the new policy holder;
storing, in the memory associated with the network database or another database, an association between the unique code of the first policy holder and the unique code stored in association with the new policy holder; and
providing a benefit to the first policy holder responsive to the act of issuing the new insurance policy, the benefit being the same as or different from the benefit incorporated in the new insurance policy.

2. The computer-implemented method for incentivizing a policy holder of an insurance company according to claim 1, wherein the benefit incorporated in the quote for the new insurance policy comprises a discount on the new insurance policy premium.

3. The computer-implemented method for incentivizing a policy holder of an insurance company according to claim 2, wherein the new insurance policy premium comprises a single insurance product.

4. The computer-implemented method for incentivizing a policy holder of an insurance company according to claim 2, wherein the new insurance policy premium comprises a plurality of insurance products, and wherein the benefit is applied to at least one of the plurality of insurance products.

5. The computer-implemented method for incentivizing a policy holder of an insurance company according to claim 1, wherein the benefit is conditioned upon maintenance of an insurance policy for a predetermined period of time.

6. The computer-implemented method for incentivizing a policy holder of an insurance company according to claim 1, further comprising:
receiving on a first computer, in association with receipt of information for a new insurance policy application, a unique code associated with each one of a plurality of policy holders;
transmitting to a second computer from the first computer, or from another computer, responsive to the act of receiving, a quote for the new insurance policy, the quote incorporating a benefit attributed to the receiving of the unique codes associated with the plurality of policy holders;
receiving on the first computer, or the another computer, an acceptance of the quote for the new insurance policy from the second computer;
issuing the new insurance policy to a new policy holder following acceptance of the quote incorporating the benefit, the act of issuing further comprising the act of updating the memory associated with the network database to store a unique code in association with the new policy holder;
storing, in the memory associated with the network database or another database, an association between the unique codes of the plurality of policy holders and the unique code stored in association with the new policy holder; and
providing a benefit to at least one of the plurality of policy holders responsive to the act of issuing the new insurance policy, the benefit being the same as or different from the benefit incorporated in the new insurance policy.

7. The computer-implemented method for incentivizing a policy holder of an insurance company according to claim 1, further comprising:
updating, in a memory associated with a network database, a unique code associated with a policy holder in the insurance company responsive to a request by a policy holder to change an association with one or more non-related policy holders in the network database.

8. The computer-implemented method for incentivizing a policy holder of an insurance company according to claim 1, further comprising:
receiving on a first computer, a request by the new policy holder to add an association with a unique code associated with another policy holder;
updating the association between the new policy holder and the another policy holder in the memory associated with the network database; and
determining, using a processing device communicatively coupled to the network database, if either of or both of the new policy holder and the another policy holder are entitled to a benefit responsive to the new association between the policy holders.

9. The computer-implemented method for incentivizing a policy holder of an insurance company according to claim 1, further comprising:
processing, using a processing device communicatively coupled to the network database, a change in a status of a policy holder; and
processing, using the processing device or another processing device communicatively coupled to the network database, a change in a status of another policy holder, not related to the policy holder, relative to the change in status of the policy holder.

10. A computer-implemented method for incentivizing a policy holder of an insurance company to increase membership in the insurance company comprising the acts of:
using a processing device, generating a unique code and associating the unique code to each policy holder in a memory associated with a database of policy holders;
receiving, in association with a first policy holder, a unique code associated with a second policy holder;
using the processing device or another processing device, associating the unique code of the first policy holder with the unique code of the second policy holder in the memory associated with the database; and
determining, using the processing device or the another processing device, if either of or both of the new policy holder and the another policy holder are entitled to a benefit responsive to the new association between the policy holders.

11. The computer-implemented method for incentivizing a policy holder of an insurance company according to claim 10, wherein the benefit comprises a discount on an existing insurance policy.

12. The computer-implemented method for incentivizing a policy holder of an insurance company according to claim 11, wherein the discount is applied to monthly premiums for a remainder of a term of the insurance policy.

13. The computer-implemented method for incentivizing a policy holder of an insurance company according to claim 11, wherein the discount is accrued during a remainder of a term of the insurance policy and is applied to a renewal of the insurance policy.

14. The computer-implemented method for incentivizing a policy holder of an insurance company according to claim 10, wherein the benefit attaches for the first policy holder only upon renewal of an existing insurance policy by both the first policy holder and the second policy holder.

15. The computer-implemented method for incentivizing a policy holder of an insurance company according to claim 10, wherein the benefit attaches for the second policy holder only upon renewal of an existing insurance policy by both the first policy holder and the second policy holder.

16. A computer-implemented method for incentivizing a policy holder of an insurance company to increase membership in the insurance company comprising the acts of:
defining, in an interface displayed on an electronic device display, at least one benefit available to a policy holder for bringing a new customer to the insurance company;
providing, in the interface displayed on the electronic device display, a contact information data entry field into which a referring policy holder can input contact information for a referee non-policy holder;
using the electronic device, or another electronic device, transmitting a policy quote to the referee non-policy holder, the policy quote incorporating a benefit associated with the referring policy holder;
issuing an insurance policy to the referee responsive to an acceptance of the quote;
providing a benefit to the referring policy holder responsive to the issuing of the new insurance policy to the referee,
wherein the benefit provided to the referring policy holder may be the same as or different from the benefit provided to the referee.

17. The computer-implemented method for incentivizing a policy holder of an insurance company according to claim 16, wherein the benefit comprises a discount on an existing insurance policy.

18. The computer-implemented method for incentivizing a policy holder of an insurance company according to claim 16, wherein the benefit provided to the referring policy holder is the same as the benefit provided to the referee.

19. The computer-implemented method for incentivizing a policy holder of an insurance company according to claim 16, wherein the electronic device comprises a computer, a portable computer, or a cellular telephone.

20. The computer-implemented method for incentivizing a policy holder of an insurance company according to claim 16, wherein the interface displayed on the electronic device display comprises an internet web-page, a facebook page, a twitter page, a blog, or another social media page.
